(19) United States
(12) Patent Application Publication
(10) Pub. No.: US 2024/0411883 A1
(43) Pub. Date: Dec. 12, 2024

(54) NONVOLATILE MEMORY ACCESS BLOCKING RESPONSIVE TO AN ATTACK

(71) Applicant: HEWLETT PACKARD ENTERPRISE DEVELOPMENT LP, Spring, TX (US)

(72) Inventors: Sukhamoy Som, Houston, TX (US); Robert L. Noonan, Crystal Lake, IL (US); Theodore F. Emerson, Tomball, TX (US)

(21) Appl. No.: 18/456,846

(22) Filed: Aug. 28, 2023

Related U.S. Application Data
(60) Provisional application No. 63/506,524, filed on Jun. 6, 2023.

(51) Int. Cl. G06F 21/56; G06F 21/55

(52) U.S. Cl. CPC G06F 21/567; G06F 21/552; G06F 21/554

(57) ABSTRACT

In some examples, a security processor detects a potential attack in a system. In response to detecting the potential attack in the system, the security processor issues a command block indication to block processing of commands to access a nonvolatile memory. The security processor determines, based on monitored information, a likelihood of the potential attack being a real attack, and in response to the determined likelihood, triggers an erase of the nonvolatile memory.

### BACKGROUND

Data in a nonvolatile memory device is maintained (not lost) when power is removed from the nonvolatile memory device or removed from a system in which the nonvolatile memory device is included. Examples of nonvolatile memory devices include flash memory devices such as NOR flash memory devices or NAND flash memory devices.

### BRIEF DESCRIPTION OF THE DRAWINGS

Some implementations of the present disclosure are described with respect to the following figures.

FIG. 1 is a block diagram of a computer system including a security processor to detect an attack in the computer system and to take a remedial action in response to the attack, according to some examples.

FIG. 2 is a flow diagram of a process according to some examples.

FIG. 3 is a block diagram of a storage medium storing machine-readable instructions according to some examples.

FIG. 4 is a block diagram of a computer system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An attacker (e.g., a human, a program, or a machine) may attempt to access sensitive data stored in a system. Due to the persistent nature of a nonvolatile memory, sensitive data stored in the nonvolatile memory is especially vulnerable to unauthorized access.

To protect the sensitive data in the nonvolatile memory from unauthorized access, a zeroization process may be triggered to erase the sensitive data. The zeroization process erases data stored in the nonvolatile memory by writing an erase pattern to the nonvolatile memory (or a portion of the nonvolatile memory). The erase pattern can include a random data pattern or any other type of data pattern that overwrites stored data in the nonvolatile memory and prevents recovery of the stored data.

A zeroization process can be triggered in response detecting an attack of a system. However, it may take a substantial amount of time to complete the zeroization process because erase operations of nonvolatile memory devices such as flash memory devices can be quite slow so that during the time interval in which the zeroization process is being performed, an attacker can still access a part of the data in the nonvolatile memory not yet erased.

An attack detection mechanism in a system may monitor certain operational aspects of the system to detect an attack on the system. The operational aspects that are monitored can include behaviors of programs or hardware components in the system, parameters produced by sensors or other monitoring agents such as operating speeds of hardware components, voltages, temperatures, tamper indications, and so forth.

In some cases, an attack alert issued by the attack detection mechanism may be a false alarm. If data in nonvolatile memory is erased in response to such a false alarm, recovery of the erased data may take considerable effort and time. In some cases, recovery of the erased data may not be possible.

In accordance with some implementations of the present disclosure, a system is able to detect a potential attack in the system by an entity. In response to detecting the potential attack, the system issues a command block indication to block processing of commands to access a nonvolatile memory. The command block indication can block access of the nonvolatile memory relatively soon (e.g., almost immediately) after the potential attack is detected, such that an attacker would not be able to access data in the nonvolatile memory, or alternatively, the attacker can access only a small amount of data in the nonvolatile memory. For example, the command block indication can be issued by performing a register write, which is a relatively rapid procedure that can be accomplished on the order of a few nanoseconds or less (e.g., less than 10 nanoseconds, or less than 5 nanoseconds, or less than 2 nanoseconds, etc.).

The command block indication provides time for the system to determine the likelihood that the potential attack is a real attack. In response to determining that the likelihood of a real attack is high, the system can trigger an erase (e.g., zeroization) of the nonvolatile memory and activate a lock to prevent further access of the nonvolatile memory. The system thus applies a multi-tier attack mitigation technique in which a command block is first applied to give time for the system to confirm the likelihood of the potential attack being a real attack, and if so, to apply a more permanent solution to protect the contents of the nonvolatile memory. By using techniques or mechanisms according to some implementations of the present disclosure, the system can ensure that a real attack is likely occurring before taking remediation actions (e.g., zeroization) that may remove data from the nonvolatile memory, while at the same time implementing a memory access blocking feature that prevents access of the data during the time that the system is confirming the likelihood of the real attack. The memory access blocking feature also prevents access of the data in the nonvolatile memory while a zeroization process is proceeding to erase data in the nonvolatile memory.

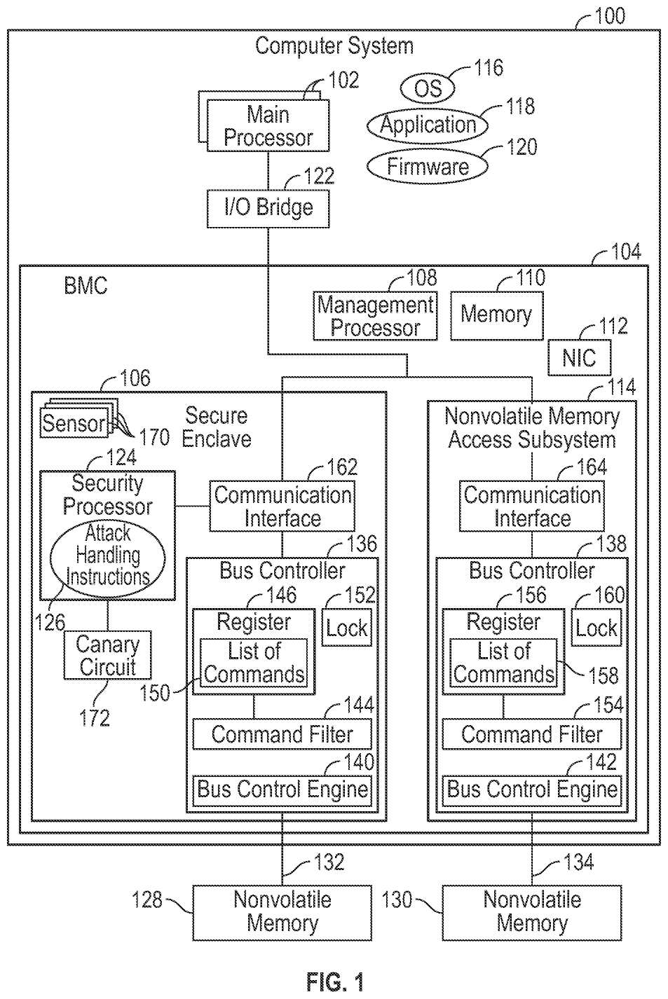

FIG. 1 is a block diagram of a computer system 100 that includes one or more main processors 102 and a baseboard management controller (BMC) 104 that performs various management tasks. Details regarding a “BMC” are provided further below. Although reference is made to a BMC in some examples, other types of controllers can be used in other examples. Examples of computer systems can include any or some combination of the following: a desktop computer, a notebook computer, a server computer, a storage system, a communication node, a vehicle, a household appliance, and so forth.

As used here, a “controller” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a “controller” can refer to a combination of one or more hardware processing circuits and machine-readable instructions (software and/or firmware) executable on the one or more hardware processing circuits.

A processor can include a microprocessor, a core of a multi-core microprocessor, a microcontroller, a programmable integrated circuit, a programmable gate array, or another hardware processing circuit.

In some examples, the BMC 104 includes a secure enclave 106, which refers to a subsystem of the BMC 104 (or any other type of controller) for which access into and out of the subsystem is more tightly controlled than access of other subsystems of the BMC 104. For example, the secure enclave 106 is fully disposed inside a cryptographic boundary. The secure enclave can also be referred to as a secure boundary or a secure perimeter or any other like term. A “cryptographic boundary” in this context refers to a continuous boundary, or perimeter, which contains the logical and physical components of a cryptographic subsystem, such as BMC components that form the secure enclave 106. The secure enclave 106 of the BMC 104, in accordance with example implementations, is isolated from the BMC's management plane and other non-secure components of the BMC 104, which are outside of the secure enclave 106. The cryptographic boundary is defined using a secure access mechanism such as by using encryption or another type of access control to protect components in the secure enclave 106 from unauthorized access by components outside the secure enclave 106.

Examples of other subsystems (non-secure subsystems) of the BMC 104 outside the secure enclave 106 include a management processor 108 of the BMC 104 that is part of the BMC's management plane. Machine-readable instructions are executable on the management processor 108 to perform management tasks of the BMC 104 (examples discussed further below).

The non-secure subsystems further include a memory 110 of the BMC 104, a network interface controller (NIC) 112 of the BMC 104, a nonvolatile memory access subsystem 114, and so forth. The NIC 112 allows the BMC 104 to communicate over a network with an external entity, which can be external of the computer system 100. The external entity can include a remote management server, for example, which allows for remote management of the computer system 100 from the remote management server using the BMC 104.

The one or more main processors 102 of the computer system 100 can execute various machine-readable instructions of the computer system 100, such as an operating system (OS) 116, an application program 118, firmware 120 (e.g., including Basic Input Output System code or Unified Extensible Firmware Interface code), and so forth. The one or more main processors 102 may be coupled to the BMC 104 through an input/output (I/O) bridge 122, which is a device that interconnects various different components.

In some examples, the secure enclave 106 includes a security processor 124 that executes attack handling instructions 126 according to some implementations of the present disclosure. The attack handling instructions 126 can include firmware, software, or other types of machine-readable instructions. The attack handling instructions 126 can be stored in a memory of the security processor 124, or in a memory outside the security processor 124 in the secure enclave 106.

The attack handling instructions 126 when executed on the security processor 124 are able to detect an attack in the computer system 100 based on information from one or more sensors. FIG. 1 depicts a collection of sensors 170 in the computer system 100. In further examples, the collection of sensors 170 can further include one or more sensors outside the computer system 100. A “sensor” can refer to a hardware sensor or machine-readable instructions executed in the computer system 100, such as by a main processor 102 or by another processor.

The collection of sensors 170 can include any or some combination of the following: a temperature sensor, a voltage sensor, an electrical sensor, a clock speed sensor, a malware detector (e.g., a virus scanner, ransomware scanner, etc.), a physical intrusion detector, and so forth.

Although FIG. 1 depicts the collection of sensors 170 being in the secure enclave 106, in further examples, one or more sensors can be external of the secure enclave 106. Such one or more external sensors can be part of the BMC 104 or can be external of the BMC 104 (e.g., coupled to the I/O bridge 122). A further example of a sensor in the BMC 104 is a digital canary circuit 172 in the secure enclave 106. A “canary circuit” refers to a circuit that malfunctions due to an environment condition-induced security attack and provides an observable indication when the malfunctioning occurs so that the indication may serve as an indicator of the attack. In some examples, the digital canary circuit 172 can apply cryptographic cipher transforms that produce an output based on a known input, and the output may be used as the indicator of a security attack. Examples of cryptographic cipher transforms that can be performed include Advanced Encryption Standard (AES) cipher transforms. A deviation of the output of the digital canary circuit 172 from an expected output indicates a malfunction and potentially indicates an environmental condition-induced security attack. Environmental conditions include a temperature of the computer system 100, a voltage of the computer system 100, an electrical current of the computer system 100, a clock speed in the computer system 100, and so forth.

The attack handling instructions 126 can detect a potential attack in the computer system 100, such as based on monitored information collected by a particular sensor of the collection of sensors 170. For example, a temperature out-of-specification condition (based on measured information from a temperature sensor), a voltage out-of-specification condition (based on measured information from a voltage sensor), a current out-of-specification condition (based on measured information from an electrical current sensor), a clock speed out-of-specification condition (based on measured information from a clock speed sensor) can indicate that a potential attack is occurring. An out-of-specification condition can refer to a condition represented by the output of a sensor deviating from an expected target behavior (e.g., a measurement may exhibit glitches that are unexpected, or a measurement can detect rapid rise or fall at a rate beyond an expected rate, etc.). The expected target behavior can be predefined or dynamically set and represented by information stored in the computer system 100.

In response to detecting the potential attack in the computer system 100, the attack handling instructions 126 can take a remediation action to ensure that data stored in one or more memories of the computer system 100 is protected from unauthorized access by an attacker. In some examples, the data to be protected from unauthorized access can reside in one or more nonvolatile memories, such as nonvolatile memories 128 and 130 depicted in FIG. 1. Although examples according to FIG. 1 depicts the presence of two nonvolatile memories that may contain sensitive data that is to be protected from unauthorized access, in other examples, a different number of nonvolatile memories (e.g., a single nonvolatile memory or more than two nonvolatile memories) can store sensitive data.

A “nonvolatile” memory device is able to persistently store data even if power were removed from the memory device. In some examples, each of the nonvolatile memories 128 and 130 is implemented with a collection of flash read-only memory (ROM) devices, such as NOR flash memory devices or NAND flash memory devices. In other examples, the nonvolatile memories 128 and 130 can be implemented using other types of memory devices.

Examples of sensitive data can include any or some combination of the following: a cryptographic key that is used to encrypt or sign data, secret information used to derive a cryptographic key or other information used for security purposes to protect data, information such as a password or another credential to verify that an entity attempting to access data is an authorized entity, and so forth. Other types of sensitive information can include proprietary information of an enterprise, personal information of users, or any other types of information that are designated for access by authorized entities and should not be accessed by non-authorized entities.

The nonvolatile memory 128 is accessible by components in the secure enclave 106, including the security processor 124. The nonvolatile memory 128 is not accessible by components external of the secure enclave 106. The nonvolatile memory 130 is accessible by components of the BMC 104, such as the management processor 108 or a component in the secure enclave 106.

The nonvolatile memory 128 is connected over a bus 132 to a bus controller 136 in the secure enclave 106. The nonvolatile memory 130 is connected over a bus 134 to a bus controller 138 in the nonvolatile memory access subsystem 114. In some cases, additional devices can be connected to the bus 132 and/or the bus 134.

A “bus” can refer to any communication link that includes a collection of signal lines (a single signal line or multiple signal lines) over which data can be transferred. In some examples, the bus 132 or 134 can be a Serial Peripheral Interface (SPI) bus. In other examples, the bus 132 or 134 can be a different type of bus, such as an Inter-Integrated Circuit (I2C) bus, or another type of bus.

In examples where the bus 132 or 134 is an SPI bus, the bus controller 136 or 138 is an SPI controller. If the bus 132 or 134 is another type of bus, then the bus controller 136 or 138 can be a different type of bus controller, such as an I2C bus controller or another type of bus controller.

The bus controller 136 includes a bus control engine 140 that controls communications over the bus 132 with the nonvolatile memory 128. The bus control engine 140 can be implemented using a portion of the hardware processing circuit or machine-readable instructions of the bus controller 136. Similarly, the bus controller 138 includes a bus control engine 142 that controls communications over the bus 134 with the nonvolatile memory 130.

The bus controller 136 also includes a command filter 144 that is able to selectively allow or disallow commands for accessing (reading or writing) the nonvolatile memory 128. Examples of commands include a read command to read data, a write command to write data, a delete command to delete data (e.g., an erase command that can erase an entire memory or some specified portion of the memory), and/or other commands.

In some examples, the bus controller 136 includes a command filter register 146 that stores a list of commands 150. A “list” of commands can refer to a single command or multiple commands. In some examples, the list of commands 150 includes a list of approved commands that are allowed to be executed with respect to the nonvolatile memory 128. In such examples, when the command filter 144 receives a command (e.g., from the security processor 124 or another entity) to access the nonvolatile memory 128, the command filter 144 compares the received command against the list of approved commands, and if the received command is part of the list of approved commands, the command filter 144 allows the received command to be executed with respect to the nonvolatile memory 128.

In a different example, the list of commands 150 can include a list of disapproved commands that are not allowed to be executed with respect to the nonvolatile memory 128. In such examples, the command filter 144 compares the received command with the list of disapproved commands, and if the received command is part of the list of approved commands, the command filter 144 blocks the received command from being executed with respect to the nonvolatile memory 128 (in effect disabling access of the nonvolatile memory 128 in response to the received command).

In response to detecting a potential attack in the computer system 100, the attack handling instructions 126 can program the command filter register 146 with the list of commands 150 to block access of the nonvolatile memory 128. In examples where the list of commands 150 is a list of approved commands, the list of commands 150 can be an empty list such that the command filter 144 would block all commands requesting access of the nonvolatile memory 128. In a different example, if the list commands 150 is a list of disapproved commands, then the list of commands 150 can include all commands that are to be blocked by the command filter 144.

Programming the command filter register 146 with the list of commands 150 to block access of the nonvolatile memory 128 gives time for the attack handling instructions 126 to determine a likelihood that the potential attack is a real attack. If the attack handling instructions 126 determines that the potential attack is likely a real attack, the attack handling instructions 126 can trigger an erase (zeroization) of the nonvolatile memory 128 and activate a lock 152 to prevent further access of the nonvolatile memory 128.

In some examples, the lock 152 can be in the form of a one-time programmable (OTP) memory in the bus controller 136 that can be programmed (written) just once. In other examples, the lock 152 can be implemented using a different mechanism.

The OTP memory can include a field that is initially set to a first value that corresponds to an unlocked state (i.e., access of the nonvolatile memory 128 is allowed), such that the bus controller 136 can allow access of the nonvolatile memory 128 if a received command is allowed by the command filter 144. However, if the field in the OTP memory is set to a second value (different from the first value) indicating access of the nonvolatile memory 128 is to be locked, then the bus controller 136 would block any further access of the nonvolatile memory 128. Setting the field of the OTP memory to the second value can be referred to as writing a lock indicator to the OTP memory.

Once the OTP memory field is written with the second value, the OTP memory field cannot be reversed, even if the computer system 100 were to be power cycled to remove power from the bus controller 136. As a result, the lock 152 is an irreversible lock. An “irreversible” lock refers to a lock that when set cannot be modified to an unlocked state, such as by a user of the computer system 100. Note that in some cases an “irreversible” lock can be reversed by an authorized entity, such as a manufacturer of the computer system 100 or another authorized entity. More generally, the lock 152 once activated is maintained in the activated state after a power cycle of the computer system 100.

Activating the lock 152 protects the nonvolatile memory 128 from unauthorized access even if the zeroization process did not succeed in erasing the content of the nonvolatile memory 128. In other examples, the lock 152 is omitted or not activated.

The bus controller 138 in the nonvolatile memory access subsystem 114 similarly includes a command filter 154, a command filter register 156 that stores a list of commands 158 (a list of approved commands or a list of disapproved commands), and a lock 160. The programming of the command filter register 156 and the setting of the lock 160 can be controlled by the attack handling instructions 126 executed by the security processor 124 in the secure enclave 106. In other examples, the security processor 124 can be implemented hardware logic such as a finite state machine to perform tasks of the attack handling instructions 126 discussed herein.

The secure enclave 106 further includes a communication interface 162 that allows components in the secure enclave 106 to communicate with components external of the secure enclave 106 (and vice versa). The nonvolatile memory access subsystem 114 also includes a communication interface 164. The communication interface 162 or 164 can include a bus interface, a network interface, and so forth. The communication interface 162 is able to control communications into or out of the secure enclave 106, including communications of the security processor 124 and traffic relating to access of the nonvolatile memory 128. The communication interface 164 handles traffic relating to access of the nonvolatile memory 130.

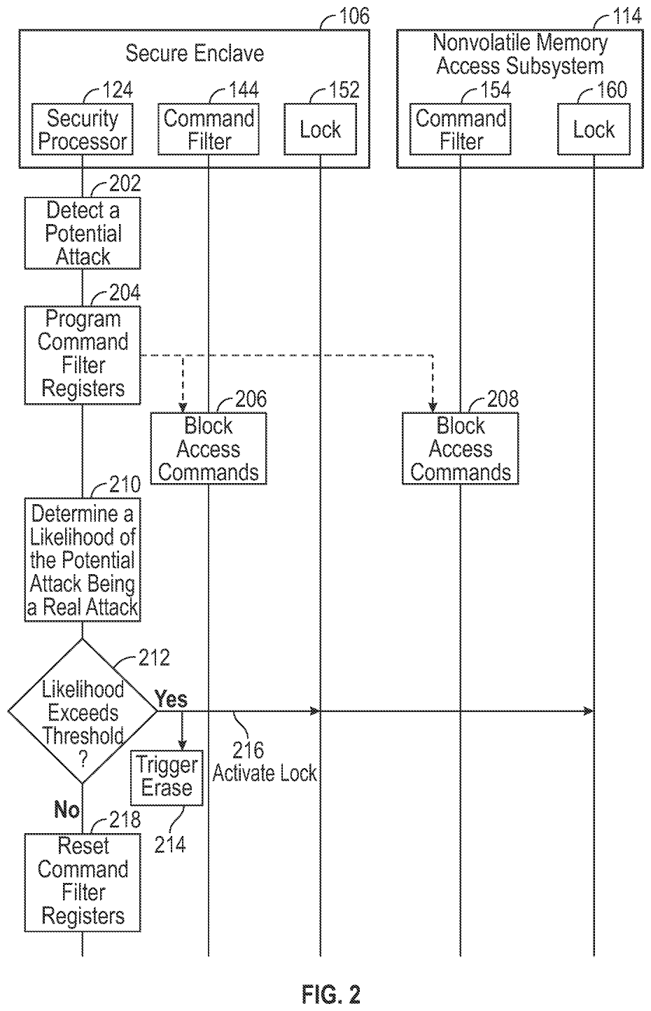

FIG. 2 is a flow diagram of an attack handling process that involves the secure enclave 106 and the nonvolatile memory access subsystem 114, in accordance with some examples of the present disclosure. Tasks of the security processor 124 depicted in FIG. 2 can be under the control of the attack handling instructions 126 of FIG. 1, for example. Alternatively, the security processor 124 can be implemented using hardware logic such as a finite state machine. Although FIG. 2 shows a specific order of tasks, in other examples, the tasks can be performed in a different order and/or in parallel, some of the tasks may be omitted, and other tasks may be added.

The security processor 124 in the secure enclave 106 detects (at 202) a potential attack in the computer system 100. This detection can be based on monitored information from a first subset of the sensors 170. For example, the detection of the potential attack may be based on a temperature measurement from a temperature sensor, a voltage measurement from a voltage sensor, a current measurement from an electrical current sensor, a tamper indication from a physical intrusion detector, and/or an alert from a malware detector. In some cases, the detection of the potential attack can be based on monitored information from more than one sensor.

In response to detecting the potential attack in the computer system 100, the security processor 124 programs (at 204) each of the command filter register 146 in the secure enclave 106 and the command filter register 156 in the nonvolatile memory access subsystem 114 with a respective list of commands (150 and 158) to block access of the respective nonvolatile memories 128 and 130. The security processor 124 can program the command filter register 156 in the nonvolatile memory access subsystem 114 by performing a register write operation through the communication interfaces 162 and 164 depicted in FIG. 1, for example.

Based on the programmed content of the command filter register 146, the command filter 144 in the secure enclave 106 blocks (at 206) access commands that seek to access the nonvolatile memory 128. Based on the programmed content of the command filter register 156, the command filter 154 blocks (at 208) access commands that seek to access the nonvolatile memory 130. The programming of the command filter registers 146 and 156 can be performed relatively quickly (e.g., almost immediately such as on the order of a few nanoseconds or less) after detecting the potential attack to prevent an attacker from performing unauthorized access of the nonvolatile memories 128 and 130. If there are other memories in the computer system 100 that are to be protected, the security processor 124 can similarly program command filter registers of such other memories to quickly block access of such other memories.

The security processor 124 then determines (at 210) a likelihood of the potential attack being a real attack. In some cases, an indicated potential attack may be the result of a malfunction in the computer system 100. For example, a sensor indicating a potential attack may malfunction. As another example, another component of the computer system 100 may malfunction that can cause a sensor to indicate a potential attack (e.g., a fan fails causing a temperature measurement to be out-of-specification, a power supply malfunction causes glitches in voltage or electrical current measurements, a clock source malfunction causes clock speeds to vary, etc.).

The determination of the likelihood of the potential attack being a real attack can be based on monitored information from one or more additional sensors in addition to the first subset of sensors used for detecting the potential attack. For example, the security processor 124 may detect the potential attack based on a measurement from a first sensor (e.g., a temperature measurement from a temperature sensor) being out of specification. The security processor 124 can determine the likelihood of the potential attack being a real attack based on checking monitored information provided by one or more other sensors, such as a voltage sensor, an electrical current sensor, a clock speed sensor, the digital canary circuit board 72, and so forth. The security processor 124 can produce a value that is representative of the likelihood of the potential attack being a real attack. For example, the security processor 124 can apply a function based on various monitored information from multiple sensors, and produces the value representative of the likelihood of the potential attack being a real attack.

The security processor 124 determines (at 212) whether the likelihood exceeds a threshold. If the likelihood exceeds the threshold, the security processor 124 triggers (at 214) an erase (zeroization) of the nonvolatile memories 128 and 130, and further, the security processor 124 activates (at 216) the lock 152 in the secure enclave 106 and the lock 160 in the nonvolatile memory access subsystem 114.

However, if the security processor 124 determines (at 212) that the likelihood of the potential attack being a real attack does not exceed the threshold, the security processor 124 resets (at 218) the command filter registers 146 and 156 so that the command filters 144 and 154 can again allow access of the respective nonvolatile memories 128 and 130. For example, if the lists of commands 150 and 158 in the command filter registers 146 and 156 are lists of approved commands, the resetting of the command filter registers 146 and 156 includes adding approved commands to the lists 150 and 158 that are allowed. As another example, if the lists of commands 150 and 158 in the command filter registers 146 and 156 are lists of disapproved commands, the resetting of the command filter registers 146 and 156 includes removing disapproved commands from the lists 150 and 158.

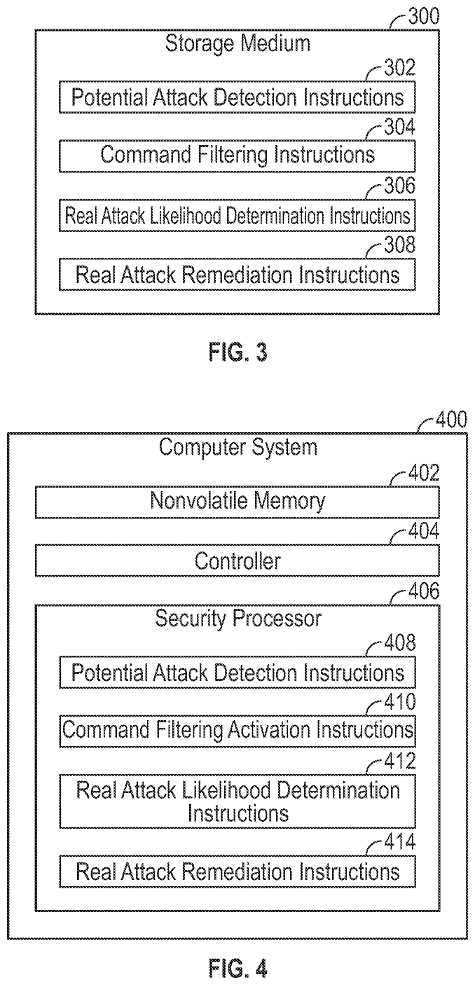

FIG. 3 is a block diagram of a non-transitory machine-readable or computer-readable storage medium 300 that stores machine-readable instructions executable to cause a security processor in a system to perform various tasks. The system can include the computer system 100, for example.

The machine-readable instructions include potential attack detection instructions 302 to detect a potential attack in the system. In some examples, the detection of the potential attack can be based on monitored information from a collection of sensors (a single sensor or multiple sensors), such as any one or more of the sensors 170 and/or the digital canary circuit 172 in FIG. 1. The potential attack may or may not be a real attack. For example, the potential attack may not be a real attack if a malfunction in the system resulted in the monitored information indicating the potential attack.

The machine-readable instructions include command filtering instructions 304 to, in response to detecting the potential attack in the system, issue a command block indication to block processing of commands to access a nonvolatile memory. For example, the command block indication can include a list of commands (approved commands or disapproved commands) written to a command filter register (e.g., 146 and/or 156 in FIG. 1). If the list of commands is a list of approved commands, then the command block indication can include an empty list of commands to block processing of any commands that seek to access the nonvolatile memory.

The machine-readable instructions include real attack likelihood determination instructions 306 to determine, based on monitored information from at least an additional sensor (in addition to the collection of sensors used to indicate the potential attack), a likelihood of the potential attack being a real attack. For example, the real attack likelihood determination instructions 306 can consider input measurement information from multiple sensors to determine the likelihood of the potential attack being the real attack.

The machine-readable instructions include real attack remediation instructions 308 to, in response to the determined likelihood satisfying a criterion, trigger an erase of the nonvolatile memory. As an example, the determined likelihood satisfying the criterion may include a value representing the likelihood exceeding a threshold.

In some examples, in response to the determined likelihood, the security processor activates a lock to prevent further access of the nonvolatile memory. The activation of the lock can include activating an irreversible lock, such as by writing a lock indicator to an OTP memory. The lock indicator can be a field set to a specified value in the OTP memory.

In some examples, the security processor can be part of a secure enclave (e.g., 106 in FIG. 1). The command filtering and the lock can be activated in a controller for the nonvolatile memory. The controller may be part of the secure enclave or external of the secure enclave. In some examples, the secure enclave may be part of a BMC (e.g., 104 in FIG. 1).

In some examples, the command block indication blocks the processing of commands to access the nonvolatile memory during a time interval that the system determines the likelihood that the potential attack is the real attack and the system erases the nonvolatile memory.

In some examples, the machine-readable instructions can remove the command block indication responsive to determining that the potential attack is unlikely to be the real attack. Removing the command block indication can include resetting the command filter register, for example.

FIG. 4 is a block diagram of a computer system 400 that includes a nonvolatile memory 402, a controller 404 for the nonvolatile memory 402, and a security processor 406. The controller 404 may be a bus controller (e.g., 136 or 138 in FIG. 1).

The security processor 406 executes machine-readable instructions to perform various tasks. The machine-readable instructions executed by the security processor 406 include potential attack detection instructions 408 to detect, based on first monitored information, a potential attack in the computer system 400. The first monitored information can be from a collection of sensors.

The machine-readable instructions executed by the security processor 406 include command filtering activation instructions 410 to, in response to detecting the potential attack in the computer system, activate command filtering to block processing of commands to access the nonvolatile memory. The activation of the command filtering includes programming a command filter register (e.g., 146 or 156 in FIG. 1).

The machine-readable instructions executed by the security processor 406 include real attack likelihood determination instructions 412 to determine, based on second monitored information, a likelihood of the potential attack being a real attack. The second monitored information can include monitored information from one or more additional sensors that are in addition to the collection of sensors.

The machine-readable instructions executed by the security processor 406 include real attack remediation instructions 414 to, in response to the determined likelihood, trigger an erase of the nonvolatile memory. During the time that the machine-readable instructions are determining the likelihood of the potential attack being the real attack and erasing the nonvolatile memory, the command filtering blocks access of the nonvolatile memory to prevent unauthorized access of the nonvolatile memory.

In some examples, the command filtering is performed by a command filter in the controller, and the lock is included in the controller.

In some examples, the nonvolatile memory is a first nonvolatile memory, and the controller is a first controller. The computer system further includes a second nonvolatile memory and a second controller for the nonvolatile memory. The security processor executes further machine-readable instructions to, in response to detecting the potential attack in the computer system, activate command filtering in the second controller to block processing of commands to access the second nonvolatile memory, and in response to the determined likelihood, trigger an erase of the second nonvolatile memory and activate a lock in the second controller to prevent further access of the nonvolatile memory.

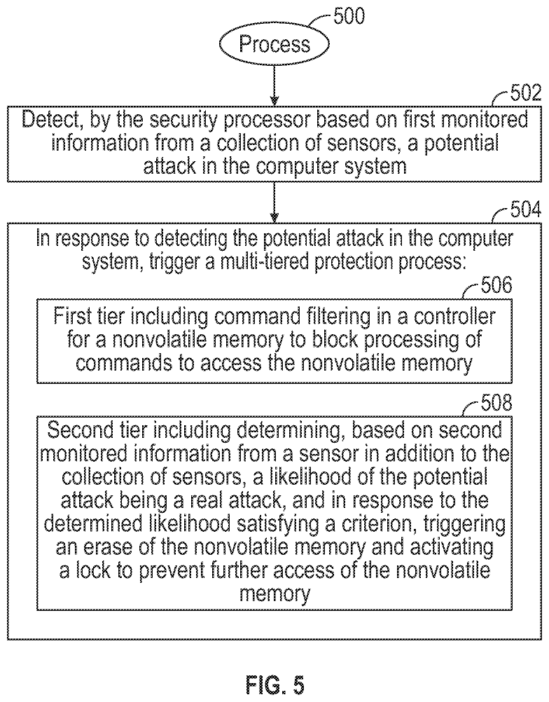

FIG. 5 is a flow diagram of a process 500, which can be performed by a security processor (e.g., 124 in FIG. 1). The process 500 includes detecting (at 502), by the security processor based on first monitored information from a collection of sensors, a potential attack in the computer system. The collection of sensors can include a single sensor or multiple sensors.

In response to detecting the potential attack in the computer system, the security processor triggers (at 504) a multi-tiered protection process. The multi-tiered protection process includes a first tier (506) that includes command filtering in a controller for a nonvolatile memory to block processing of commands to access the nonvolatile memory.

The multi-tiered protection process further includes a second tier (508) that includes determining, based on second monitored information from a sensor in addition to the collection of sensors, a likelihood of the potential attack being a real attack, and in response to the determined likelihood satisfying a criterion, triggering an erase of the nonvolatile memory and activating a lock to prevent further access of the nonvolatile memory.

A “BMC” can refer to a specialized service controller that monitors the physical state of a computer system using sensors and communicates with a remote management system (that is remote from the computer system) through an independent “out-of-band” connection. The BMC can perform management tasks to manage components of the computer system. Examples of management tasks that can be performed by the BMC can include any or some combination of the following: power control to perform power management of the computer system (such as to transition the computer system between different power consumption states in response to detected events), thermal monitoring and control of the computer system (such as to monitor temperatures of the computer system and to control thermal management states of the computer system), fan control of fans in the computer system, system health monitoring based on monitoring measurement data from various sensors of the computer system, remote access of the computer system (to access the computer system over a network, for example), remote reboot of the computer system (to trigger the computer system to reboot using a remote command), system setup and deployment of the computer system, system security to implement security procedures in the computer system, and so forth.

In some examples, the BMC can provide so-called “lights-out” functionality for a computer system. The lights out functionality may allow a user, such as a systems administrator, to perform management operations on the computer system even if an OS is not installed or not functional on the computer system.

Moreover, in some examples, the BMC can run on auxiliary power provided by an auxiliary power supply (e.g., a battery); as a result, the computer system does not have to be powered on to allow the BMC to perform the BMC's operations. The auxiliary power supply is separate from a main power supply that supplies powers to other components (e.g., a main processor, a memory, an input/output (I/O) device, etc.) of the computer system.

In some examples, in addition to the BMC in each computer system, an additional management controller (separate from the BMCs) can be used to interact with the BMCs to perform management of the computer system. In examples where the computer systems are server computers (or other types of computer systems) mounted in a rack, the additional management controller can be referred to as a rack management controller (RMC). A “rack” refers to a mounting structure that has supports for multiple computer systems.

A storage medium (e.g., 300 in FIG. 3) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a security processor in a system to:
detect a potential attack in the system;
in response to detecting the potential attack in the system, issue a command block indication to block processing of commands to access a nonvolatile memory;
determine, based on monitored information, a likelihood of the potential attack being a real attack; and
in response to the determined likelihood, trigger an erase of the nonvolatile memory.

2. The non-transitory machine-readable storage medium of claim 1, wherein the instructions upon execution cause the security processor to, in response to the determined likelihood, activate a lock to prevent further access of the nonvolatile memory.

3. The non-transitory machine-readable storage medium of claim 2, wherein the activation of the lock comprises writing a lock indicator to a one-time programmable (OTP) memory.

4. The non-transitory machine-readable storage medium of claim 2, wherein the lock is irreversible and maintained after a power cycle of the system.

5. The non-transitory machine-readable storage medium of claim 1, wherein the command block indication is provided to a command filter that blocks one or more commands for accessing the nonvolatile memory.

6. The non-transitory machine-readable storage medium of claim 5, wherein the security processor is part of a secure enclave, and the command filter is external of the secure enclave.

7. The non-transitory machine-readable storage medium of claim 5, wherein the security processor and the command filter are part of a secure enclave.

8. The non-transitory machine-readable storage medium of claim 5, wherein the command filter is to block the one or more commands based on a list of commands stored in a register.

9. The non-transitory machine-readable storage medium of claim 1, wherein the detection of the potential attack is based on an output of a first sensor, and the determining of the likelihood of the potential attack being the real attack is further based on an output of a second sensor different from the first sensor.

10. The non-transitory machine-readable storage medium of claim 1, wherein the command block indication blocks the processing of the commands during a time interval in which the system determines the likelihood that the potential attack is the real attack and the system erases the nonvolatile memory.

11. The non-transitory machine-readable storage medium of claim 1, wherein the instructions upon execution cause the security processor to:
remove the command block indication responsive to determining that the potential attack is unlikely to be the real attack.

12. A computer system comprising:
a nonvolatile memory;
a controller for the nonvolatile memory; and
a security processor to:
detect, based on first monitored information, a potential attack in the computer system;
in response to detecting the potential attack in the computer system, activate command filtering to block processing of commands to access the nonvolatile memory,
determine, based on second monitored information, a likelihood of the potential attack being a real attack, and
in response to the determined likelihood indicating that the potential attack is the real attack, trigger an erase of the nonvolatile memory.

13. The computer system of claim 12, wherein the security processor is to, in response to the determined likelihood indicating that the potential attack is the real attack, activate a lock to prevent further access of the nonvolatile memory, the lock once activated remains activated when the computer system is power cycled.

14. The computer system of claim 13, wherein the activation of the lock comprises writing a lock indicator to a one-time programmable (OTP) memory in the controller.

15. The computer system of claim 12, wherein the command filtering is performed by a command filter in the controller, and wherein the security processor is to reset the command filtering in response to determining that the potential attack is unlikely to be the real attack.

16. The computer system of claim 15, wherein the controller comprises a register including a list of commands useable by the command filter to determine whether a received command to access the nonvolatile memory is to be blocked, and wherein the activation of the command filtering comprises programming the register with the list of commands.

17. The computer system of claim 12, wherein the nonvolatile memory is a first nonvolatile memory, and the controller is a first controller, the computer system further comprising:
a second nonvolatile memory;
a second controller for the nonvolatile memory,
wherein the security processor is to:
in response to detecting the potential attack in the computer system, activate command filtering in the second controller to block processing of commands to access the second nonvolatile memory,
in response to the determined likelihood, trigger an erase of the second nonvolatile memory and activate a lock in the second controller to prevent further access of the nonvolatile memory.

18. The computer system of claim 17, wherein the security processor and the first controller are part of a secure enclave, and the second controller is external of the secure enclave.

19. A method to protect a computer system, comprising:
detecting, by a security processor based on first monitored information from a collection of sensors, a potential attack in the computer system;
in response to detecting the potential attack in the computer system, triggering, by the security processor, a multi-tiered protection process comprising:
a first tier that includes command filtering in a controller for a nonvolatile memory to block processing of commands to access the nonvolatile memory, and
a second tier that includes determining, based on second monitored information from a sensor in addition to the collection of sensors, a likelihood of the potential attack being a real attack, and in response to the determined likelihood satisfying a criterion, triggering an erase of the nonvolatile memory and activating a lock to prevent further access of the nonvolatile memory.

20. The method of claim 19, wherein the command filtering is applied by the controller based on a register programmed with a list of commands, and the lock comprises a one-time programmable (OTP) memory.
